(19) United States
(12) Patent Application Publication
(10) Pub. No.: US 2013/0249704 A1
(43) Pub. Date: Sep. 26, 2013

(54) EXPANDABLE TUBULAR ANTENNA FEED LINE FOR THROUGH CASING E/M COMMUNICATION

(71) Applicant: Peter S. Aronstam, Houston, TX (US)

(72) Inventor: Peter S. Aronstam, Houston, TX (US)

(21) Appl. No.: 13/822,163

(22) PCT Filed: Sep. 15, 2011
(86) PCT No.: PCT/US11/51816

§ 371 Date: May 22, 2013

Related U.S. Application Data
(60) Provisional application No. 61/382,966, filed on Sep. 15, 2010.

(51) Int. Cl. G01V 3/30

(52) U.S. Cl. CPC G01V 3/30
USPC 340/854.4

(57) ABSTRACT

The invention generally relates to data transmission in a wellbore. In one aspect, a system for communicating electromagnetic waves in a wellbore is provided. The system includes a sensor equipment package for sensing a parameter in the wellbore and generating an electromagnetic wave. The system further includes an expandable composite tubular having a conducting member and an insulating member. The composite tubular is configured to be expanded from a first diameter to a second larger diameter, wherein the composite tubular in the second larger diameter forms a connection with the wellbore. In another aspect, a method of using a system for communicating electromagnetic waves in a wellbore is provided. In a further aspect, a system for providing electrode contact surfaces between a sensor equipment package and a surrounding tubular disposed in a wellbore is provided.

### BACKGROUND OF THE INVENTION

1. Field of the Invention

This invention relates to data transmission in a wellbore. More particularly, the invention relates to an expandable tubular antenna feed line for electromagnetic communication.

2. Description of the Related Art

In the production of an oil well it is important to maintain knowledge of the reservoir pressure in order to maximize the production from the field. For this reason, sensors are installed in the well on completion to provide this data. Unfortunately, over the lifetime of a given well it is highly likely the original sensor will fail, leaving the operator without information. In recent times various groups have begun working on replacement sensors that are wireless in order to avoid the huge costs of re-completion. For instance, a wireless sensor may be placed in a wellbore casing at an appropriate location. On activation, the wireless sensor sends an electromagnetic (“E/M”) signal through the earth-to-surface receiver, thus bringing the sensor's data to a point where it can be recovered by the user.

In order to impart an E/M signal, it is necessary to inject time varying current into the earth through the well casing over distances of many meters. A conventional E/M device 50 is illustrated in FIG. 1. The E/M device 50 includes a cylindrical body 25 that includes the components of the E/M device 50. The body 25 is coupled to production tubing 20 by slips 31 and 32, which when energized, protrude radially out of the body 25 and wedge the E/M device 50 in place within the production tubing 20. The slips 31, 32 also serve as the current injection points for the E/M signal which is created in an electronics package 35 of the E/M device 50. The total length of the E/M device 50 is dominated by the spacing required between the slips 31, 32 in the body 25. Modeling suggests the minimum spacing L1 is 33 feet (10 meters). The length of the E/M device 50 makes the entire tool unwieldy to transport and handle during well intervention operations. The E/M device 50 further includes a sensor and battery pack 34, and a power generation member 33, whose combined length may be on the order of 3.3 feet (1 meter). Once installed the E/M device 50 is a self-powered device that is designed to measure a relevant reservoir parameter and relay the data to the surface. It is also a requirement that a passageway exist through the E/M device 50 to allow the flow of wellbore fluids 40 to proceed through the E/M device 50. The conventional E/M device tends to occupy a large part of the wellbore cross-section and, as such, presents an impediment to flow. Therefore, there is a need for another E/M device that minimizes the restriction of the wellbore cross-section.

### SUMMARY OF THE INVENTION

This invention generally relates to data transmission in a wellbore. In one aspect, a system for communicating electromagnetic waves in a wellbore is provided. The system includes a sensor equipment package for sensing a parameter in the wellbore and generating an electromagnetic wave. The system further includes an expandable composite tubular having a conducting member and an insulating member. The composite tubular is configured to be expanded from a first diameter to a second larger diameter, wherein a portion of the composite tubular in the second larger diameter is used as current injection points for the electromagnetic wave generated by the sensor equipment package.

In another aspect, a method of using a system for communicating electromagnetic waves in a wellbore is provided. The method includes the step of positioning a composite tubular in the wellbore. The method further includes the step of expanding the composite tubular from a first diameter to a second larger diameter such that the composite tubular engages the wellbore. The method also includes the step of coupling a sensor equipment package to the composite tubular. Furthermore, the method includes the step of sensing a parameter in the wellbore. Additionally, the method includes the step of generating an electromagnetic wave that is transmitted through current injection points in the expanded composite tubular.

In a further aspect, a system for providing electrode contact surfaces between a sensor equipment package and a surrounding tubular disposed in a wellbore is provided. The system includes a conducting tubular. The system further includes an insulating tubular bonded to the conducting tubular. The conducting tubular is disposed within the insulating tubular such that a portion of the conducting tubular extends from an end of the insulating tubular at one end and a portion of the insulating tubular extends from the conducting tubular at an opposite end. Additionally, the system includes an electrode ring disposed adjacent the portion of the insulating tubular that extends from the conducting tubular. The tubulars and the electrode ring are configured to be expanded from a first diameter to a second larger diameter to form electrode contact surfaces that are used between the sensor equipment package and the surrounding tubular.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a view illustrating a conventional E/M device.

FIG. 2 is a view illustrating an E/M communication device disposed within a wellbore.

FIGS. 3A and 3B are views illustrating the placement of a composite tubular within a tubing member.

FIGS. 4A and 4B are views illustrating the composite tubular.

FIG. 5 is a view illustrating a sensor equipment package disposed in the composite tubular.

FIG. 6 is a view illustrating the E/M communication device disposed in the tubing.

### DETAILED DESCRIPTION

The present invention generally relates to an expandable tubular antenna feed line for electromagnetic communication. The present invention is designed to create a wireless “antenna” system in the well to enable E/M data communication to the surface. The invention makes use of expandable tubular technology to make remote electrical contact with a casing in a wellbore without occupying much of the cross-sectional area of the well. To better understand the novelty of the E/M communication device of the present invention and the methods of use thereof, reference is hereafter made to the accompanying drawings.

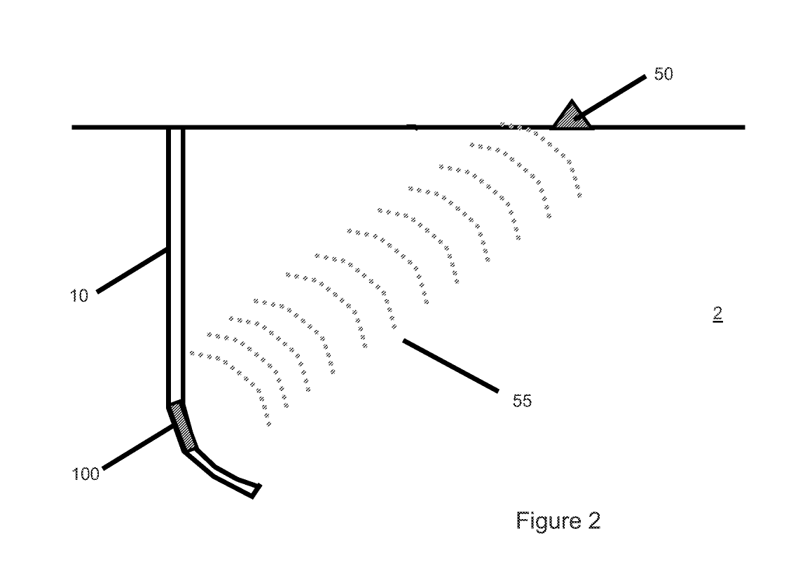

FIG. 2 is a view illustrating an E/M communication device 100 of the present invention disposed within a casing 10 of a wellbore. The device 100 is placed in the wellbore casing 10 at an appropriate location. On activation, the device 100 sends an E/M signal 55 through the earth to a surface receiver 50. The downhole data may be recovered from the surface receiver 50 by a user. The E/M communication device 100 generally includes a sensor equipment package that is coupled to an expandable composite tubular.

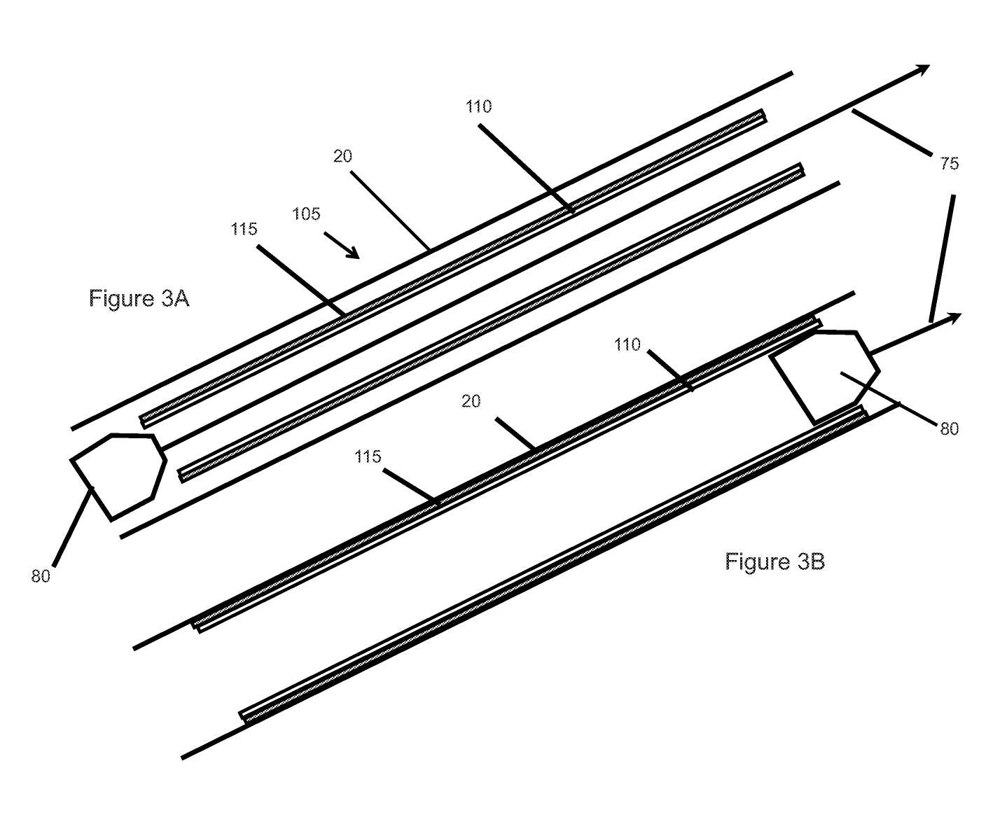

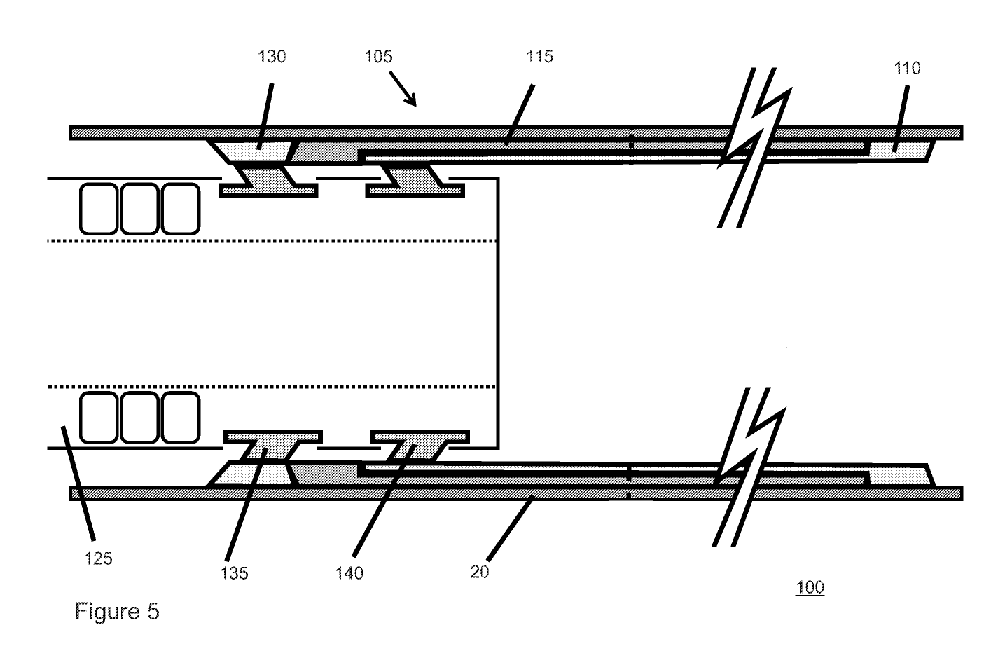

FIGS. 3A and 3B are views illustrating the placement of a composite tubular 105 within a tubing 20 (e.g., production tubing) disposed within the casing (not shown). As will be described herein, the composite tubular 105 of the device 100 will be used with a sensor equipment package. The composite tubular 105 includes a conducting member 110 that is made from a material that is capable of being an electrical conductor, such as copper, gold, or aluminum. The composite tubular 105 further includes an insulating member 115 that is made from a material that is capable of being an electrical insulator, such as Teflon or a fluoroelastomer. The composite tubular 105 also includes an electrode band 130 that is attached to an end portion of the insulating member 115 (FIG. 5). The electrode band 130 is made from a material that is capable of being an electrical conductor, such as copper, gold, or aluminum.

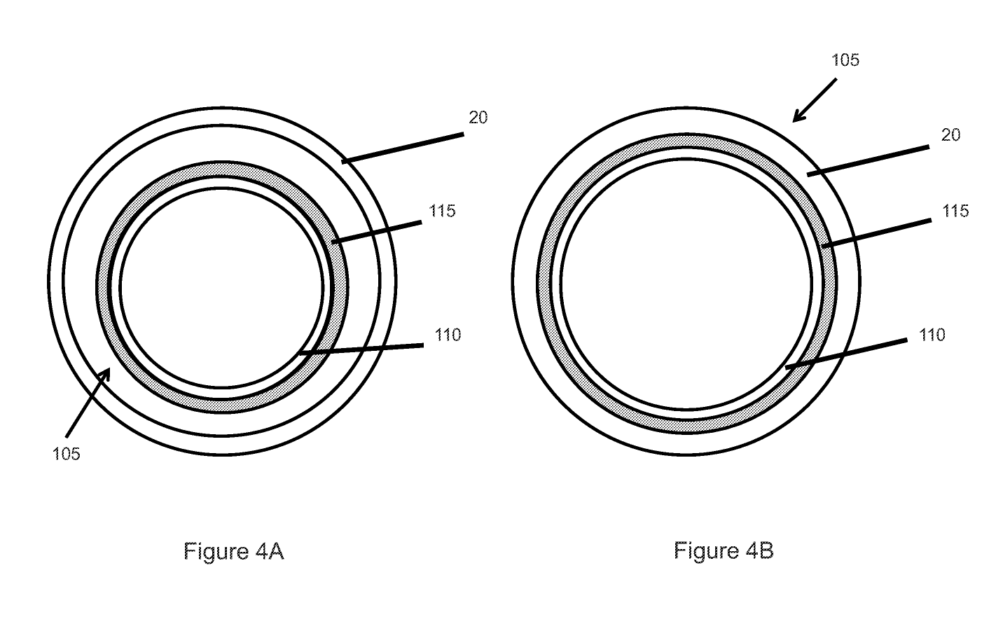

The composite tubular 105 and an expansion device 80 may be lowered into the tubing 20 via a work string 75. In one embodiment, the composite tubular 105 is attached to the expansion device 80 by a shearable connection (not shown). After the composite tubular 105 is positioned within the tubing 20, the shearable connection may be released and the expansion device 80 may move relative to the composite tubular 105. The expansion device 80 may be urged through the composite tubular 105 to enlarge the composite tubular 105 from a first diameter (FIG. 4A) to a second larger diameter (FIG. 4B). As shown, the composite tubular 105 is in contact with the surrounding tubing 20. Once installed, the composite tubular 105 provides an insulated conductor the length of the device 100.

FIGS. 4A and 4B are views illustrating the composite tubular 105. In the initial state, the composite tubular 105 is formed in a cylindrical shape to the length and diameter as required for the specific installation. The outer diameter of the unexpanded composite tubular 105 must be sufficiently smaller than the inner diameter of the tubular 20 in order to be inserted in the wellbore. After expansion, the composite tubular 105 looks as shown in FIG. 4B and is uniformly expanded to contact the tubular wall 20. In another embodiment, the composite tubular 105 is corrugated, such that the outer diameter of the composite tubular 105 is non-uniform.

FIG. 5 is a view illustrating a sensor equipment package 125 disposed in the composite tubular 105. After the composite tubular 105 is expanded into contact with the surrounding tubing 20, the expansion device is removed from the composite tubular 105, and the sensor equipment package 125 is coupled to the composite tubular 105. This is a two-step process. In the first step, the composite tubular 105 is lowered and expanded into the tubing 20. In the second step, the sensor equipment package 125 is positioned within the expanded composite tubular 105. In another embodiment, the expansion of the composite tubular 105 and the placement of the sensor equipment package 125 may be done in a single-step process. In the single-step process, the composite tubular 105 and the sensor equipment package 125 are lowered together. The sensor equipment package 125 includes an expansion cone (not shown) that is used to expand the composite tubular 105 from the first diameter to the second larger diameter. Thereafter, the sensor equipment package 125 (and the expansion cone) remains within the expanded composite tubular 105. In a further embodiment of the single-step process, the composite tubular 105, the sensor equipment package 125 and a removable expansion device (not shown) are lowered together on the workstring. The removable expansion device expands the composite tubular 105 to enlarge the composite tubular 105 from the first diameter to the second larger diameter, and then the sensor equipment package 125 is positioned within the composite tubular 105. Thereafter, the removable expansion device is removed from the wellbore, while the composite tubular 105 and the sensor equipment package 125 remain in the wellbore.

As shown in FIG. 5, the conducting member 110 is designed to overhang the insulating member 115 at one end of the composite tubular 105, thereby providing a contact directly to the tubing 20. At the other end of the composite tubular 105, the insulating member 115 extends beyond the conducting member 110, thereby insulating the conducting member 110 from the tubing 20 and an electrode band 130. Once expanded, the composite tubular 105 provides two electrode contact surfaces to the tubing 20 separated by the length of expanded composite tubular 105.

At the points where the conducting member 110 and the electrode band 130 contact the wall of the tubing 20, there may be placed sharp slip-like grooves (not shown) to insure the contact with the tubing 20 is of low resistance. Such grooves or slips are configured to cut into the surface of the wall of the tubing 20 to expose good metal below any corrosion or dirt which may be present. Additionally, in one embodiment, the conducting member 110 and electrode band 130 (and the grooves or slips) are plated with gold to reduce corrosion while disposed in the wellbore.

Once the composite tubular 105 is installed and expanded in the wellbore, the sensor equipment package 125 can be lowered into the well. Once the sensor equipment package 125 is located within the composite tubular 105, slips 135, 140 (or deployable contacts) are activated to engage the conducting portions of the expanded composite tubular 105, contacting the upstream electrode band 130 and the conducting member 110. The slip arrangement gives an E/M generator (not shown) within the sensor equipment package 125 access to current injection points at the distal ends of the expanded composite tubular 105.

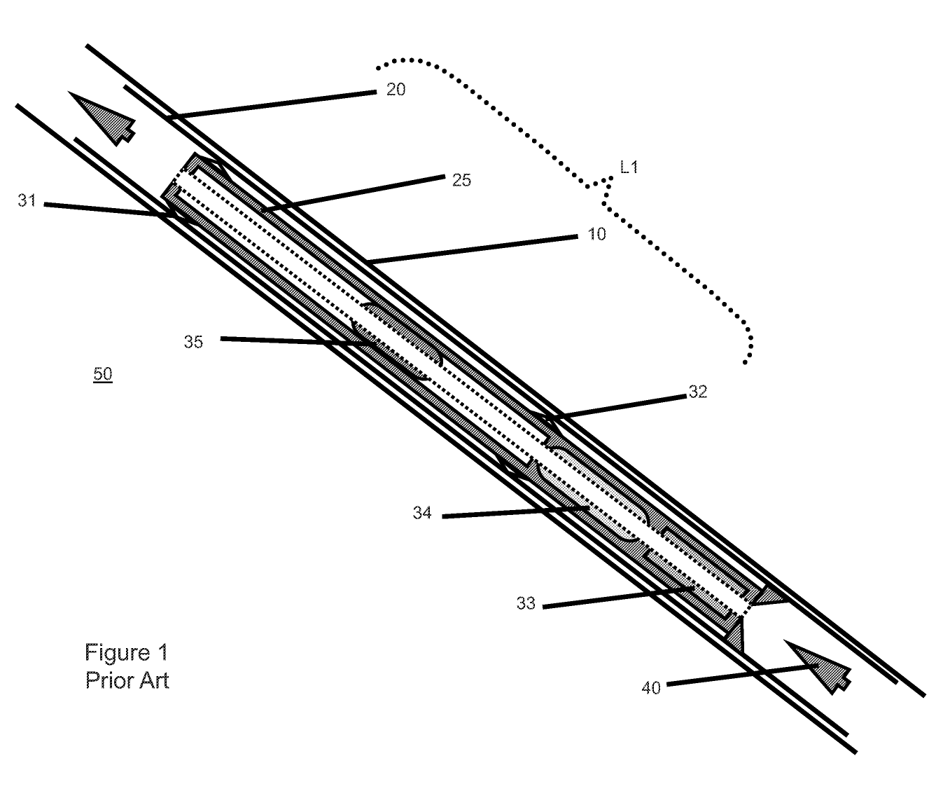

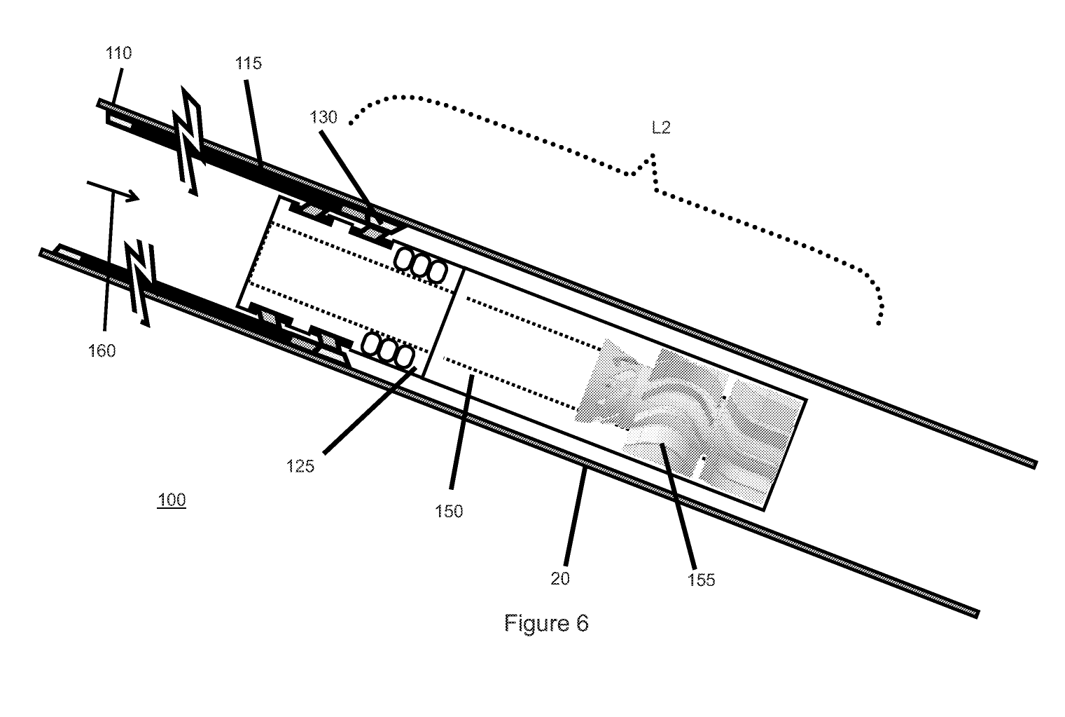

FIG. 6 is a view illustrating the device 100 disposed in the tubing 20. As shown, the device 100 further includes a sensor and battery pack 150 and a turbine 155. As shown, the device 100 is a self-powered instrument device that is equipped with the turbine 155. The turbine is configured to be powered by flow 160 in the wellbore. The device 100 comprsing the sensor equipment package 125 coupled to the composite tubular 105 by expanding internal slips into contact with the electrode band 130 and the conducting member 110. The benefit of the arrangement shown in FIG. 6 is that the total well obstruction has been reduced from in excess of 33 feet (10 meters) as in the conventional E/M device 50 (see L1 on FIG. 1) to less than 6.6 feet (2 meters) in the device 100 (see L2 on FIG. 6), thereby greatly reducing the pressure loss in the well due to its presence.

In another aspect, the setting tool used to deliver the instrument package or the instrument package itself could also serve as the expansion device for the composite tubular. In this manner the entire system could be installed in a well in a single pass as set forth herein, and the instrument package would reside at the downstream end of the composite tubular after installation, which is the reverse of what is shown in FIG. 6.

In a further aspect, the composite tubular is a pre-assembled composite of insulating outer material and conducting inner shell. The insulating material is chosen for properties that will insure complete insulating coverage after expansion of the inner shell. The invention also provides for penetrating ridges imbedded in the conductor at the distal end to insure low resistivity contact is made on expansion.

In an additional aspect, a system and method of providing an insulated feed line allows remote placement of a current injection point. The invention is for the placement of current injection electrodes for creating E/M signals in the earth adjacent to a borehole. The invention may however be used to provide an insulated pathway along a borehole for any purpose.

In a further aspect, the object of this invention is to provide an alternative method of creating injection points along the production tubing, thereby shortening the overall equipment package and reducing the resistance to flow.

Although the descriptions above contain many specifications, these should not be construed as limiting the scope of the invention but as merely providing illustrations of some of the presently preferred embodiments of this present invention. Further, it should be understood that the invention is not to be unduly limited to the foregoing which has been set forth for illustrative purposes. Various modifications and alternatives will be apparent to those skilled in the art without departing from the true scope of the invention, as defined in the following claims. While there have been illustrated and described particular embodiments of the present invention, it will be appreciated that numerous changes and modifications will occur to those skilled in the art, and it is intended in the appended claims to cover those changes and modifications which fall within the true spirit and scope of the present invention.

While the foregoing is directed to embodiments of the present invention, other and further embodiments of the invention may be devised without departing from the basic scope thereof, and the scope thereof is determined by the claims that follow.

1. A system for communicating electromagnetic waves in a wellbore, the system comprising;
a sensor equipment package for sensing a parameter in the wellbore and generating an electromagnetic wave; and
an expandable composite tubular having a conducting member and an insulating member, wherein the composite tubular is configured to be expanded from a first diameter to a second larger diameter, and wherein a portion of the composite tubular in the second larger diameter is used as current injection points for the electromagnetic wave generated by the sensor equipment package.

2. The system of claim 1, wherein the insulating member is disposed around the conducting member.

3. The system of claim 1, further comprising grip members disposed on an outer surface of the composite tubular that are configured to grip the wellbore upon expansion of the composite tubular.

4. The system of claim 1, wherein the composite tubular is expanded by an expansion device.

5. The system of claim 1, further comprising an electrode ring disposed adjacent an end of the composite tubular.

6. The system of claim 1, wherein the composite tubular is expanded by an expansion portion of the sensor equipment package.

7. The system of claim 1, wherein the sensor equipment package is coupled to the composite tubular by extendable slips.

8. The system of claim 1, wherein the sensor equipment package is powered by a turbine that generates power by flow of fluid in the wellbore.

9. The system of claim 1, wherein the conducting member is disposed within the insulating member and includes a portion that extends from an end of the conducting member.

10. A method of using a system for communicating electromagnetic waves in a wellbore, the method comprising:
positioning a composite tubular in the wellbore;
expanding the composite tubular from a first diameter to a second larger diameter such that the composite tubular engages the wellbore;
coupling a sensor equipment package to the composite tubular;
sensing a parameter in the wellbore; and
generating an electromagnetic wave that is transmitted through current injection points in the expanded composite tubular.

11. The method of claim 10, further comprising urging an expansion device through the composite tubular to expand the composite tubular from the first diameter to the second larger diameter.

12. The method of claim 10, wherein the sensor equipment package is coupled to the composite tubular after the composite tubular has been expanded to the second larger diameter.

13. The method of claim 10, wherein the sensor equipment package expands the tubular from the first diameter to the second larger diameter during coupling to the composite tubular.

14. The method of claim 10, further comprising generating power for the sensor equipment package by a turbine that uses fluid flow in the wellbore.

15. The method of claim 10, wherein coupling the sensor equipment package to the composite tubular is done by activating slips attached to the sensor equipment package.

16. The method of claim 10, wherein the composite tubular includes an inner conducting member and an outer insulating member.

17. A system for providing electrode contact surfaces between a sensor equipment package and a surrounding tubular disposed in a wellbore, the system comprising:
a conducting tubular;
an insulating tubular bonded to the conducting tubular, wherein the conducting tubular is disposed within the insulating tubular such that a portion of the conducting tubular extends from an end of the insulating tubular at one end and a portion of the insulating tubular extends from the conducting tubular at an opposite end, and
an electrode ring disposed adjacent the portion of the insulating tubular that extends from the conducting tubular, wherein the tubulars and the electrode ring are configured to be expanded from a first diameter to a second larger diameter to form electrode contact surfaces that are used between the sensor equipment package and the surrounding tubular.

18. The system of claim 17, wherein an outer portion of the tubulars include grip members at the electrode contact surfaces.

19. The system of claim 17, wherein the electrode contact surfaces are gold plated to reduce corrosion.

20. The system of claim 17, wherein the insulating tubular is made from Teflon or a fluoroelastomer.
